(19) United States
(12) Patent Application Publication
(10) Pub. No.: US 2009/0210712 A1
(43) Pub. Date: Aug. 20, 2009

(54) METHOD FOR SERVER-SIDE DETECTION OF MAN-IN-THE-MIDDLE ATTACKS

(76) Inventor: Nicolas Fort, Bordeaux (FR)

Correspondence Address: CONNOLLY BOVE LODGE & HUTZ LLP, 1875 EYE STREET, N.W., SUITE 1100, WASHINGTON, DC, 20006, US

(21) Appl. No.: 12/033,462

(22) Filed: Feb. 19, 2008

(51) Int. Cl. H04L 9/32

(52) U.S. Cl. 713/175

(57) ABSTRACT

Problem The combination of a tendency towards permissivity when verifying certificate authenticity and the use of in-band client authentication opens up an opportunity for attackers to mount man-in-the-middle attacks on SSL connections.

Solution The invention exposes any discrepancy between the intended recipient of the client credential and the actual recipient of the client credential by cryptographically including parameters that are uniquely linked to the channel (i.e., the communication session, as characterized by the parameters of the protocols that are being used), preferably the channel end points, in the calculation of the client credential. This links the process that provides the secure channel (e.g., the SSL protocol session) to the process that provides the authentication credential (e.g., the OTP token operation), thus exposing any attack that would break up the client-server channel. This is achieved without the requirement for an additional encrypted tunnel and allowing the continued use of existing components such as existing browsers.

### TECHNICAL FIELD

The present invention relates to the field of securing electronic data connections; more specifically the field of detection of man-in-the-middle attacks.

### BACKGROUND ART

Web-based applications such as e-commerce or internet banking have a need for mutual authentication of the parties involved in the transaction (the client and the server), and for privacy of the messages exchanged between these parties. The Secure Socket Layer (SSL) protocol [FREIER, A., et al. The SSL 3.0 Protocol. Netscape Communications Corp. Nov. 18, 1996.] is commonly used to provide authentication of the server and mutual privacy, and is being transformed into an “Internet Standard” as the Transport Layer Security (TLS) Protocol [DIERKS, T., et al. RFC 4346: The Transport Layer Security (TLS) Protocol, Version 1.1. IETF Network Working Group. April 2006.]. In the remainder of this application, the sign “SSL” is understood to cover both the Secure Socket Layer protocol and the Transport Layer Security protocol.

Server authentication relies on the authenticity of the server's public key infrastructure (PKI) certificate, which is presented to the client during session set-up, and which must be signed by a trusted certification authority (CA). The authenticity of the server's certificate is automatically verified by software that is built into all modern web browsers, by verifying the CA's signature on the server's certificate (or certificate chain) using the CA's public key. It is generally understood that, in the words of the TLS specification, “server authentication is required in environments where active man-in-the-middle attacks are a concern”, and that “if the server is authenticated, its certificate message must provide a valid certificate chain leading to an acceptable certificate authority.” However, it has been observed that “the PKI client embedded in most browsers is so permissive that the overall security level is rather low” [FERGUSON, Niels, et al. Practical Cryptography. Indianapolis: Wiley Publishing, 2003. ISBN 0471223573. p. 369.].

Specifically, undesired servers may be accepted for SSL-connections by the browser when the certificate is cryptographically sound, but awarded to a different proprietor and uniform resource locator (URL) than the one the user wishes to connect to, as users often don't notice that they are using the wrong URL. Browsers may contain a certificate from—and thus award trust to—a questionable CA; in this respect it is noteworthy that not all CAs apply adequate verification and registration policies. Furthermore, many computer users cannot adequately assess the concrete risk posed by manually accepting a certificate that their browser reports as “unverifiable”, and will proceed to set up an encrypted session with an untrustworthy server.

Acceptance of untrustworthy certificates is generally believed to be the main problem of the otherwise very respectable SSL protocol, because it invalidates one of the assumptions upon which SSL's cryptographical soundness is built, to with the fact that an illegitimate server will always be discovered through examination of its certificate.

Although SSL also provides mechanisms for mutual authentication, these can only be used when the client possesses a certified PKI key pair as well. In practice, however, in many real-world applications clients don't possess or cannot be assumed to possess a PKI key pair certified by a CA that is trusted by the application server. In such cases client authentication for transactions with individuals is usually performed in-band using some other authentication mechanism once the encrypted channel with the authenticated server has been set up. Thus, many current e-commerce, banking, webmail, and on-line community sites authenticate clients by means of methods based on shared secrets (e.g. static passwords, credit card numbers, personal questions, etc.) [SMITH, Richard E. Authentication: From Passwords to Public Keys. Addison-Wesley, 2002. ISBN 0201615991. p. 395.].

The combination of a tendency towards permissivity when verifying server certificate authenticity and the use of in-band client authentication opens up an opportunity for attackers to mount a type of attack commonly called “man-in-the-middle attacks” (MITMA). One possible MITMA scheme consists of an attacker (A) purporting to be a legitimate server (S) towards a genuine client (C). The client sets up an SSL connection with A's masquerading server, believing he is actually connected to S's legitimate server. In its interaction with the genuine client C, the attacker A may obtain the genuine client C's secrets, which will allow the attacker A to impersonate the genuine client C in another subsequent or concurrent connection with the legitimate server S. The attacker A can only successfully communicate with the genuine client C if the attacker A presents a public key to the genuine client C for which the attacker A owns the corresponding private key; otherwise, subsequent encrypted messages from the genuine client C would be undecryptable for the attacker A. This implies that the attacker A cannot present the legitimate server S's public key, and thus the attacker A must rely on the fact that the genuine client C will not notice that a different public key is being presented.

For SSL, a solution consisting of an additional in-band authentication of the server has been proposed in the past [US 2002/2166048, WO 02/091662 A (VASCO DATA SECURITY, INC.) 2002 Nov. 14]. In that solution, the server presents a credential to the client, based on cryptographically combining at least its PKI certificate and a shared secret. If an attacker were to intercept this server credential and relay it to a client, the client would notice the discrepancy between the attacker's PKI certificate and the credential presented. The disadvantage of this approach is that the legitimate server has no way of verifying that the genuine client has successfully verified this server credential.

A different approach consists of making intercepted client credentials less valuable to attackers. In that light, the use of one-time passwords (OTP) for client authentication, instead of static shared secrets, reduces the risk of a successful attack according to the scheme described above. OTPs are cryptographically derived from a base secret known only to the client and the authentication server, and from a dynamic variable which is explicitly or implicitly known to both client and server, possibly within certain margins of uncertainty or accuracy. Examples of said dynamic variable include a challenge generated by the server, a counter, and a time value, or any combination thereof. When the data used to generate an OTP includes a challenge generated by the server, the OTP may be called a “response”. Hardware tokens as well as programs for computers to generate such OTPs at the client side are known in the art. Programs for computers to verify at the server side the OTP submitted by the client are also known in the art. [U.S. Pat. No. 4,599,489 (GORDIAN SYSTEMS, INC.) 1984 Feb. 22 WO 85/03785 A (GORDIAN SYSTEMS, INC.) 1985 Aug. 29]

The main advantages of OTPs over static passwords are (1) that they are cryptographically hard to generate without knowledge of the base secret, (2) that they can only be used by an attacker if they are intercepted before they reach the authentication server, (3) that they automatically expire upon use, when the following OTP is received by the authentication server (counter-based OTP), when the associated time window ends (clock-based OTP), or when a new challenge is generated by the server (challenge-based OTP).

OTPs generated by tokens as currently known in the art remain vulnerable to a so-called real-time man-in-the-middle attack. This is a MITMA scheme in which the attacker is simultaneously connected to the client (towards which it purports to be the legitimate server) and to the server (towards which it purports to be the genuine client), acting as a bi-directional proxy. The attacker obtains a valid OTP from the client, and immediately uses it to fraudulently authenticate with the server. The best known defense against this attack scheme is to limit the amount of damage an attacker can do on the basis of the OTP authentication alone, by additionally requiring an electronic signature from the client for each individual transaction of a certain value that is carried out after the initial authentication [MENNES, Frederik. Best Practices for Strong Authentication in Internet Banking. ISSA Journal. December 2007, p. 6-10.]. Such an electronic signature may be supplied in the form of an OTP, whereby data that is characteristic of the message or the transaction is cryptographically combined with the shared secret to generate an authentication code that serves as a signature. A particular kind of electronic signature cryptographically combines transaction data and at least a second type of dynamic value, such as a counter or a time value or a challenge, with the shared secret in order to provide resistance against replay attacks. The terms “OTP”, “client credential”, and “authentication credential” shall hereinafter be understood to also include OTPs derived from message or transaction data, also known as “signatures”. The use of signatures is not always an adequate solution against MITMA because quite often it can not be ruled out that the MITM is capable of manipulating the data to be signed.

The real-time man-in-the-middle attack is possible due to the fact that the process that provides the secure channel is not cryptographically linked to the process that provides client authentication credentials, i.e. there is no cryptographic channel binding. This insight has been elaborated in the prior art [ASOKAN, N., et al. Man-in-the-Middle in Tunneled Authentication Protocols. http://eprint.iacr.org/2002/163. Nov. 11, 2002.]. The prior art solution focuses on fixing the vulnerabilities of tunneled authentication protocols in typical mobile wireless network topologies. The prior art solution can be applied to the use of the Extensible Authentication Protocol (EAP) between an EAP peer and a back-end authentication server to perform authentication of said EAP peer and provide a session key for subsequent encrypted communication between said EAP peer and a network access server, where the entire EAP protocol run is protected by an outer protocol providing authentication of the back-end authentication server and encryption (e.g., the Pre-IKE Credential Provisioning Protocol or SSL).

The prior art solution to the MITMA vulnerability consists of generating a new ultimate session key K for a communication tunnel between the EAP peer and the network access server, which is implicitly or explicitly bound to a secret known only to the EAP peer and its home authentication server. In implicit binding, the ultimate session key K is cryptographically derived from a specific secret S (either the session key derived in the authentication and key agreement protocol or the EAP peer's long-term authentication key), known only to the EAP peer and the EAP peer's home authentication server, and from the outer protocol's master key T. In explicit binding, K is computed independently by the EAP peer and the binding agent, and a verification value V is computed from S and T, which is then verified between the EAP peer and the EAP peer's home authentication server. Obviously, the EAP peer's home authentication server has to transmit the relevant information to the network access server via a trusted channel, in order for the new encrypted tunnel between the EAP peer and the network access server to be initiated.

The prior art does not contemplate the use of the channel binding concept to provide protection against man-in-the-middle attacks in e-commerce client-server exchanges. The tunneled-EAP network topology can be made equivalent to the e-commerce client-server topology described earlier if the EAP peer is mapped onto the client and the network access server and the back-end authentication server are folded together and mapped onto the server. Under this mapping, the prior-art solution can be used to provide implicit or explicit binding between the SSL session parameters (outer protocol) and the session parameters of a new encrypted tunnel to be set up between the client and the server.

The solution resulting from mapping the prior-art solution to the client-server topology is highly impractical for the purpose of authenticating client-server transactions in that it requires setting up an additional encrypted tunnel following successful channel binding in the first tunnel. This particular requirement implies that the method cannot be used to improve the security in client-server transactions carried out through existing SSL-enabled web browsers.

The installed base of web browsers favors a solution that relies on elements that are readily accessible to applets running in the “virtual machine” offered by the browser. This is not the case for ephemeral session keys.

Furthermore, the prior-art solution is flawed in relation to SSL-based client-server exchanges to the extent that it uses the SSL master secret as its secret T. It is inherent to the master secret establishment method of SSL, that a real-time man-in-the-middle can relay the respective nonces and pre-master secret that are transmitted by the genuine client and the legitimate server for the calculation of the master secret, thus forcing an identical master secret on the channel between the attacker and the genuine client, and on the channel between the attacker and the legitimate server, respectively. Hence, neither the master secret, nor the SSL session key, which is derived from the master secret, can reliably be used to provide any form of channel binding. This flaw is recognized by Asokan et al., stating that “If the outer protocol allows MitM to influence the value of the session key, then MitM can arrange T1 to be the same as T2. In this case, explicit binding of session keys alone is not sufficient to detect existence of the MitM.” However, no adequate remedy is offered, because Asokan merely states: “Therefore some data input which is specific to the client should be used in the computation of the explicit binding value.” This remedy is not further elaborated, and turns out to be insufficient.

Even when the client's long-term authentication key is used as the secret S, the identified weakness of the master key T implies that any explicit channel binding check value that is valid on the channel between the genuine client and the attacker may successfully be relayed from the attacker to the legitimate server. This evidences the fact that the prior art method cannot be directly transposed to the client-server authentication space.

The prior art solution is also disadvantageous in that the legitimate server has no way of verifying that the genuine client has successfully verified the server's authenticity.

Finally, the prior art solution cannot be generalized to situations where there is no outer protocol to authenticate the server and to provide a cryptographic tunnel for client authentication.

### DISCLOSURE OF THE INVENTION

### Technical Problem

The combination of a tendency towards permissivity when verifying certificate authenticity and the use of in-band client authentication opens up an opportunity for attackers to mount man-in-the-middle attacks on SSL connections. Implicit and explicit binding schemes that defend connections against man-in-the-middle attacks are known in the art. The problem is that the known schemes require setting up an additional encrypted tunnel, after the establishment of the original secure channel, and that they exhibit specific vulnerabilities when used with SSL as the outer protocol.

### Technical Solution

The present invention is based on the insight that the real-time man-in-the-middle attack can be avoided or at least detected by incorporating one or more data elements that characterize the communication channel into the client credential generation process. This cryptographically links the process that provides the communication channel (e.g., the SSL protocol session) to the process that provides the authentication credential (e.g., the OTP token operation), without the requirement for an additional encrypted tunnel and without the requirement to change the communication protocol.

According to the state of the art, OTPs are client credentials that are cryptographically derived from a base secret known only to the client and the authentication server, and from a dynamic variable such as a challenge and/or a counter and/or a clock and/or message or transaction data also maintained by said client and said server.

It is an object of the invention to expose any discrepancy between the intended recipient of the client credential and the actual recipient of the client credential by cryptographically including parameters that are uniquely linked to the channel (i.e., the communication session, as characterized by the parameters of the protocols that are being used), preferably the channel end points, in the calculation of the client credential. These parameters must be cryptographically combined at the client's side, to avoid (or more precisely to enable detection at the server side of) alteration of the channel-based parameters during the transmission of the client credential.

The SSL session between a client and an entity at the other side of the link, whether it be an attacker or a legitimate server, is characterized by, among other things, the entity's server public key and its associated PKI certificate chain presented by said entity during the SSL session setup phase. Such a server public key and its associated certificate chain, as it is, may be more or less trustworthy in the eyes of an individual user, but it is hard to forge in the cryptographic sense of the word. If an attacker were to present the legitimate server's public key to the genuine client, subsequent communications from the genuine client would be of no use to the attacker without knowledge of the corresponding private key. Hence, including a distinctive part of this server public key and/or its associated certificate chain in the calculation of the client credential, will cryptographically link the client credential to the entity that presented the server public key and associated certificate chain. If that entity is an attacker, the client credential will be tied to the attacker's certificate, and will be rejected by the legitimate server, which obviously presented a different server public key and associated certificate chain.

In the case of a web-based exchange, the communication session between a client and an entity at the other side of the link, whether it be an attacker or a legitimate server, is further characterized by, among other things, the domain name of said entity, or more specifically the full uniform resource locator (URL) of the content presented by said entity. It is impractical for an attacker to forge this URL or domain name, because this URL or domain name controls, through the standard domain name resolution process, which server IP address will be used as the destination for any packets originating from the client as part of said communication session. A successful forgery of the URL would apparently require subverting the domain name system (DNS) infrastructure used by the client. Hence, including the entity's URL or domain name in the calculation of the client credential, will cryptographically link the client credential to the entity with which the client communicates. If that entity is an attacker, the client credential will be tied to the attacker's URL, and will be rejected by the legitimate server, which obviously holds a different URL.

The Internet Protocol (IP) communication session between a client and an entity at the other side of the link, whether it be an attacker or a legitimate server, is also characterized by, among other things, the IP address of said entity. It is impractical for an attacker to forge this IP address, because this IP address controls the route that will be followed by any packets originating from the client as part of said communication session. A successful forgery of the IP address would apparently require subverting a router through which all relevant traffic would have to pass. Hence, including the entity's IP address in the calculation of the client credential, will cryptographically link the client credential to the entity with which the client communicates. If that entity is an attacker, the client credential will be tied to the attacker's IP address, and will be rejected by the legitimate server, which obviously holds a different IP address and will use its own IP address when verifying the client's credentials.

It is a further object of the invention to expose any discrepancy between the client that generated the client credential and the actual sender of the client credential by cryptographically including parameters that are uniquely linked to the channel (i.e., the communication session, as characterized by the parameters of the protocols that are being used), preferably the channel end points, in the calculation of the client credential. These parameters must be cryptographically combined at the client's side, to avoid alteration (or more precisely to enable detection at the server side of) of the channel-based parameters during the transmission of the client credential.

An IP communication session between the legitimate server and the entity at the other side of the link, whether it be an attacker or a legitimate client, is characterized by, among other things, the IP address of the client, which is under the control of the client and/or the client's Internet Service Provider. It is impractical for an attacker to forge this IP address, because this IP address controls the route that will be followed by any packets destined for the client as part of said communication session. A successful forgery of the IP address would apparently require subverting a router through which all relevant traffic would have to pass. Hence, including the client's IP address in the calculation of the client credential, will cryptographically link the client credential to the IP connection's client end point. If the credential is replayed by an attacker, the client credential will be tied to the legitimate client's IP address, and will be rejected by the server, which will use the attacker's IP address when verifying the client's credentials.

A communication session between a first entity on a first side of a link, whether it be an attacker or a legitimate server, and a second entity on a second side of a link, whether it be an attacker or a legitimate client, is further characterized by, among other things, any session key or any random nonce exchanged between the entities as part of the link setup protocol. Hence, including such cryptographic key material in the calculation of the client credential, will cryptographically link the client credential to the secure channel. If the credential is replayed by an attacker, the client credential will be tied to the legitimate client's secure channel, and will be rejected by the server, which will use the cryptographic key material associated with the secure channel between the server and the attacker for its calculation.

The cryptographic combination of the relevant elements can for example be achieved by concatenating the channel or channel end point related parameters with a dynamic variable such as a server challenge and/or a clock and/or counter-based information and/or message or transaction data, and subsequently transforming said concatenation with a well-known symmetric cipher such as DES, 3DES, AES, RC4, blowfish, and twofish, or by subsequently hashing said concatenation by means of a keyed hash algorithm such as SHA and HMAC, using the base secret as the key. These examples are not limitative, as it shall be obvious for someone skilled in the art that many other methods and algorithms exist to cryptographically combine the channel or channel end point related parameter(s) and dynamic variable(s) with at least one secret shared between client and server.

The cryptographic combination of the relevant elements can be achieved by means of inter alia a program running on the end point's computer or a dedicated apparatus (such as for example a strong authentication token or a smart card or a USB token), into which relevant parameters, including optionally the shared secret, are stored or entered by means of a built-in keyboard or an electronic interface with the end point's computer.

The cryptographic combining of the relevant elements can also be partly done on the end point's computer and partly on a dedicated apparatus. For example, in one embodiment, the data element characterizing the communication channel is hashed together with a dynamic variable (such as a counter, a time value, a server challenge, or message or transaction data) on the client computer and the resulting hash is then submitted to a security device (such as a smart card or USB token) connected to the client's computer to be encrypted by said security device using a symmetric encryption algorithm and a secret key stored on said security device and known to the legitimate server. Alternatively, a dynamic variable such as for example a time value and/or a counter and/or a server challenge and/or message or transaction data is cryptographically combined in a strong authentication token device with a secret stored in said token device and known by the server to yield an intermediate OTP. Said intermediate OTP is then transferred to the client computer and on said client computer cryptographically combined with one or more data elements characterizing the client-server communication channel. These examples are not limitative, someone skilled in the art will be aware that many other methods, algorithms, and arrangements exist to cryptographically combine the relevant elements partly on the end point's computer and partly on a dedicated apparatus.

The received authentication credential is verified at the server side. To this end, the server performs a verification on a set of variables comprising the received authentication credential, the local copy of the shared secret, the locally accessible instances of the selected channel parameters, and optionally one or more dynamic values.

The conditions that define a positive verification result may be different for different applications. In one application model, a positive verification result requires strict identity between the client's instances of each variable used in the credential generation process and their respective server-side counterparts. In another application model, a positive verification result requires strict identity between the client's instances of some of the variables used in the credential generation process and their respective server-side counterparts, while allowing a bounded difference between the client's instances of other variables used in the credential generation process and their respective server-side counterparts. In a third application model, the server may perform the verification process repeatedly with different sets of values for the local instances of the variables used in the credential generation process, and declare the verification successful if any of these sets of values yield a positive verification result according to one of the previous application models. These application models are not limitative.

The verification involves the application of a cryptographic function to a first subset of said set of variables, in order to obtain results that can be compared to a second subset of said set of variables, or variables derived therefrom, wherein the second subset is typically the complement of the first subset. A person skilled in the art will see that there may be different ways to choose the first subset and the second subset of the set of variables, given a particular choice of a cryptographic combination technique at the client side.

Consider the case where the client generates an authentication credential by concatenating the channel parameters and optionally one or more dynamic values, and symmetrically encrypting the resulting concatenation using the shared secret as an encryption key. In a first exemplary embodiment of the verification process, the server decrypts the authentication credential using the shared secret as a decryption key (this involves applying a cryptographic function to a first subset of variables), to extract the channel parameters and the dynamic values (this corresponds to obtaining results that can be compared to a second subset of variables), and compares the latter to the locally available instances of the same variables to determine the outcome of the verification. In another exemplary embodiment, the server encrypts the concatenation of the locally available instances of the selected channel parameters and optionally one or more dynamic values using the shared secret as a key (this involves applying a cryptographic function to a first subset of variables), to re-create the authentication credential (this corresponds to obtaining results that can be compared to a second subset of variables), and then compares the received authentication credential to the one locally created to determine the outcome of the verification.

Consider the case where the client generates an authentication credential by concatenating the channel parameters and optionally one or more dynamic values, calculating a hash value of the resulting concatenation, and symmetrically encrypting the resulting hash using the shared secret as an encryption key. In an exemplary embodiment, the server decrypts the received client credential using the shared secret as a key (this involves applying a cryptographic function to a first subset of variables), to obtain a first intermediate value (this corresponds to obtaining results that can be compared to variables derived from a second subset of variables), and creates a hash from the concatenation of the channel parameters and optionally one or more dynamic values, to obtain a second intermediate value (this corresponds to deriving variables from the second subset of variables), and then compares the first and second intermediate values to determine the outcome of the verification.

### ADVANTAGEOUS EFFECTS

The advantage of the invention is that if the client includes channel and/or channel end point related parameters in the calculation of the client credential, a mismatch will occur in the verification calculations of the authenticating server whenever the client and the server are not connected by the same channel, and subsequently the authentication request will be refused by the authenticating server when the authenticating server can thus not successfully verify the client credential. This prevents an attacker from masquerading as the client by using a client credential that was generated on a different channel, notably on a fraudulent SSL protocol session.

### BRIEF DESCRIPTION OF THE DRAWINGS

FIG. 1 schematically illustrates the message exchanges involved in setting up an SSL connection and authenticating the client in band.

FIG. 2 schematically illustrates the message exchanges involved in the presence of interference by a man in the middle attack.

FIG. 3 schematically shows a prior-art apparatus (301), such as an authentication token.

FIG. 4 schematically shows how an authentication token can be used in implementing the credential generation process according to the invention (401), and

FIG. 5 repeats certain elements from FIG. 1 and FIG. 4 to illustrate a preferred use of the invention.

### DETAILED DESCRIPTION OF PREFERRED EMBODIMENTS

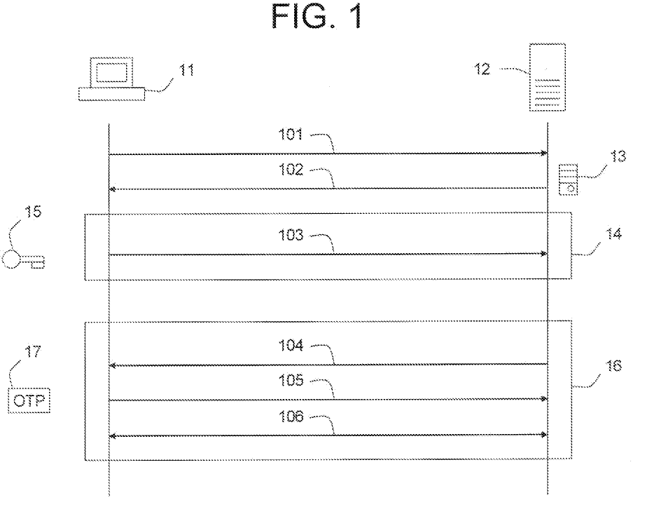

FIG. 1 shows the usual procedure for setting up an SSL connection and authenticating the client in band. A client (11) sends an initial message (101) containing a client nonce to a server (12). The server (12) responds with a message (102) containing a server nonce and a server public key with certificate (13). This public key (13) is used to secure the communications represented in box (14) by means of public key encryption. The client (11) sends a message (103) encrypted with the server's public key (13) to the server (12), containing a randomly generated pre-master secret (15) that can be used along with the nonces previously exchanged to derive the session key; this happens independently at the client (11) side and the server (12) side. The session key is used to secure the communications represented in box (16) by means of symmetric encryption. These messages may for example consist of an initial display message (104) from the server (12), which may include a password challenge, followed by a message (105) from the client (11) containing a one-time password (17), which is generated on the basis of a shared secret along with possibly a clock input, and/or a counter input, and/or a challenge input. If the one-time password (17) is accepted by the server (12), both parties may proceed with their transactions (106).

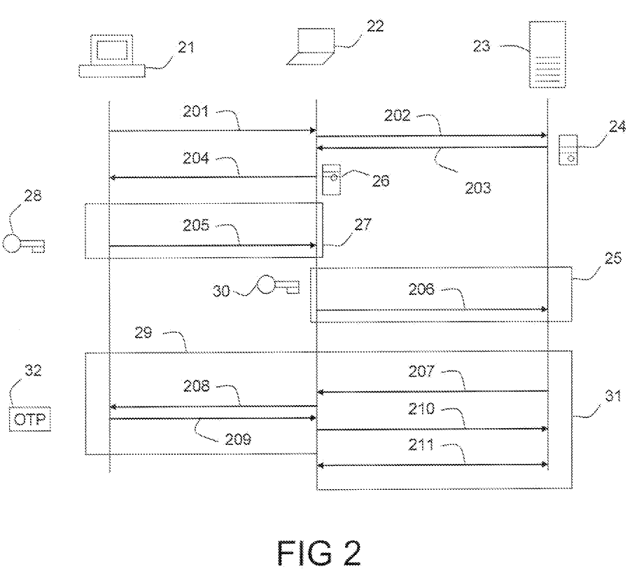

FIG. 2 shows the interference of a man in the middle. A client (21) sends an initial message (201), intended for a server (23), but in fact received by an attacker (22). The attacker (22) sets up a concurrent session with the legitimate server (23) by sending an initial message (202). The legitimate server (23) responds with a message (203) containing a server nonce and a public key certificate (24). This public key (24) is used to secure the communications represented in box (25) by means of public key encryption. The attacker (22) now responds to the initial message (201) from the client (21) with a message (204) containing a server nonce and a forged server public key with certificate (26). This forged public key (26) is used to secure the communications represented in box (27) by means of public key encryption. The client (21) sends an encrypted message (205) to the attacker (22), containing a randomly generated pre-master secret (28) that can be used along with the nonces previously exchanged to derive the session key; this happens independently at the client (21) side and the attacker (22) side. The session key is used to secure the communications represented in box (29) by means of symmetric encryption. The attacker (22) now replicates this behavior and sends an encrypted message (206) to the legitimate server (23), containing a randomly generated pre-master secret (30) that can be used along with the nonces previously exchanged to derive the session key; this happens independently at the attacker (22) side and the legitimate server (23) side. The session key is used to secure the communications represented in box (31) by means of symmetric encryption. Note that by duplicating the nonces and the pre-master secrets across the two links, the attacker (22) can force the same session key for its communication with the client (21) and with the legitimate server (23), if he so desires. The following messages may for example consist of an initial display message (207) from the legitimate server (23) to the attacker (22), which may include a password challenge, and which is then replayed as a message (208) from the attacker (22) to the client (21). The client (21) responds with a message (209) containing a one-time password (32), which is generated on the basis of a shared secret along with possibly a clock input, and/or a counter input, and/or a challenge input. This message (209) is then replayed as a message (210) from the attacker (22) to the legitimate server (23). If the one-time password (32) is accepted by the legitimate server (23), the attacker (22) can now conduct transactions (211) with the server (23) in the name of the genuine client (21), i.e., the man-in-the-middle attack is successful. If, however, the one-time password (32) is generated according to the present invention, by cryptographically including information about a channel end point in the OTP generation, the attack would fail: the one-time password (32) generated by the client (21), including information from the public key certificate (26) of the attacker (22) would be different from the one-time password expected by the legitimate server (23), which should include information from the public key certificate (24) of the legitimate server (23).

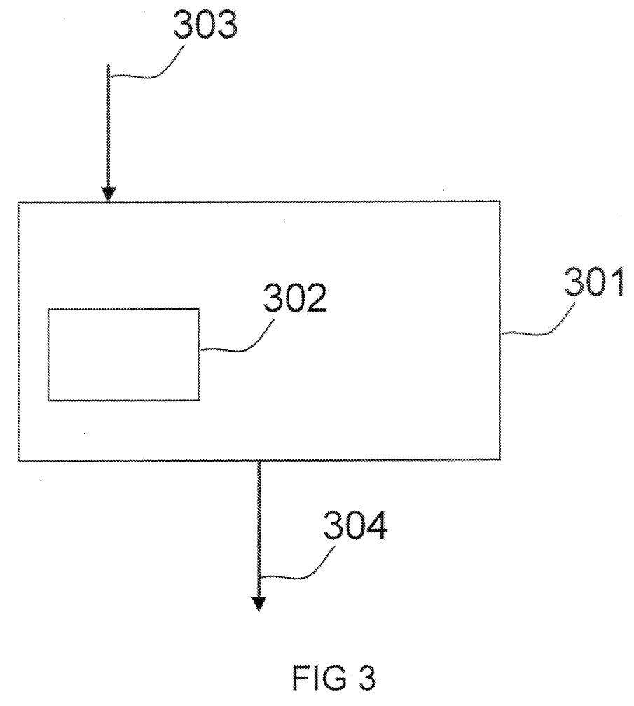

FIG. 3 schematically shows a prior-art apparatus (301), such as an authentication token, to authenticate a client in a client-server transaction by generating an authentication credential (304) based on a cryptographic function of a shared secret (302) and a dynamic variable (303) such as a clock or a counter maintained by said client and said server.

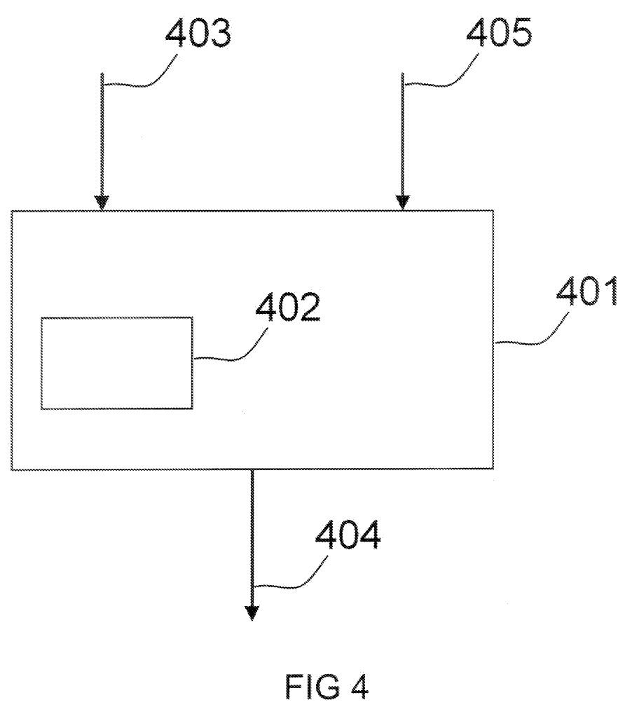

FIG. 4 schematically shows an apparatus implementing the credential generation process according to the invention. As seen in FIG. 4, an agent (401), such as an authentication token, allows the authentication of a client in a client-server transaction by generating an authentication credential (404) based on a cryptographic function of at least a shared secret (402), optionally a dynamic variable (403) such as a clock or a counter maintained by said client and said server, and distinctive channel information (405). The agent may comprise a microelectronic device such as an Application-Specific Integrated Circuit (ASIC) or a microprocessor.

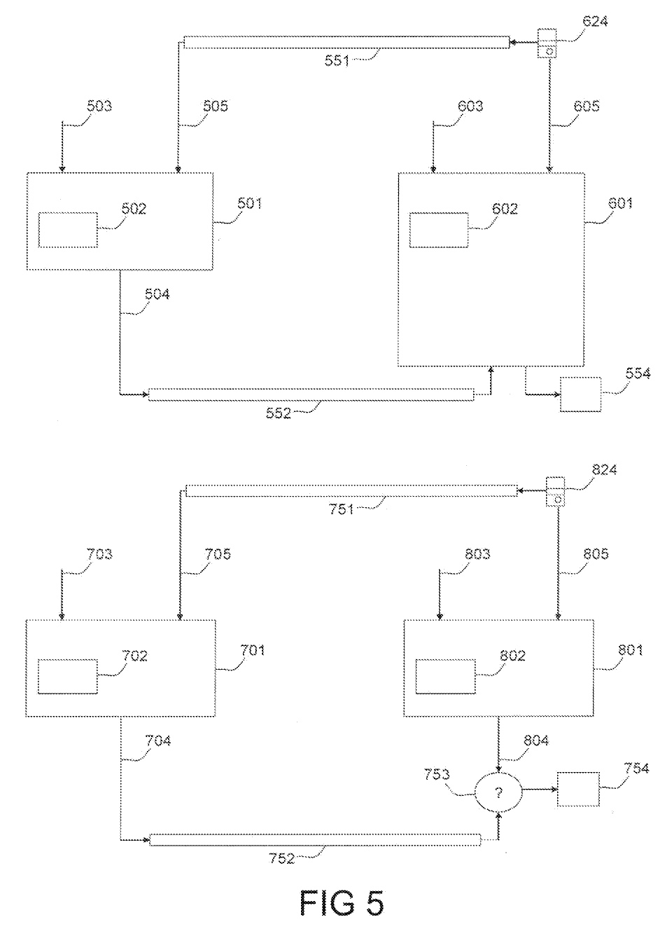

FIG. 5 repeats certain elements from FIG. 1 and FIG. 4 to illustrate a preferred use of the invention. The server public key (624) is transmitted from the server to the client via a server-client channel (551) to be used by the client's credential generation agent or token (501), along with a shared secret (502) and an optional dynamic variable (503), for the calculation of a client credential (504). The client transmits the client credential (504) to the server via a secure client-server channel (552). The server-client channel (551) and the client-server channel (552) are represented independently here, but they may in reality be different messages on the same physical channel. The original server public key (624) is also used by the server's verification process (601), along with a shared secret (602) and an optional dynamic variable (603), for the verification of the client credential (604). The client credential (504) as received via the secure client-server channel (552) is also provided to the server's verification process (601) to produce an authentication result (554). By design, for a genuine client, the shared secret at the client side (502) is identical to the shared secret at the server side (602), and the optional dynamic variable at the client side (503) corresponds to the optional dynamic variable at the server side (603). For those cases where the server only knows the value of the dynamic variable as used by the client within certain margins of accuracy, the prior art contains methods to resolve this uncertainty (for example various time or counter synchronization methods for time and/or counter based OTPs are well-known in the prior art). Hence, the success of the verification performed by (601) depends necessarily on the identity of the server public key (624) used in the respective calculations of client and server. If a MITMA has compromised the integrity of the channels (551) or (552), the respective versions of the server public key will not be identical, which will cause the verification in (601) to fail.

FIG. 6 repeats certain elements from FIG. 1 and FIG. 4 to illustrate another preferred use of the invention, which is a special case of the use illustrated in FIG. 5. The server public key (824) is transmitted from the server to the client via a server-client channel (751) to be used by the client's credential generation agent or token (701), along with a shared secret (702) and an optional dynamic variable (703), for the calculation of a client credential (704). The client transmits the client credential (704) to the server via a secure client-server channel (752). The server-client channel (751) and the client-server channel (752) are represented independently here, but they may in reality be different messages on the same physical channel. The original server public key (824) is also used by the server's verification process (801), along with a shared secret (802) and an optional dynamic variable (803), for the calculation of a verification copy of the client credential (804). The verification copy (804) and the client credential (704) as received via the secure client-server channel (752) are compared by the verification agent (753) to produce an authentication result (754). By design, for a genuine client, the shared secret at the client side (702) is identical to the shared secret at the server side (802), and the optional dynamic variable at the client side (703) corresponds to the optional dynamic variable at the server side (803). For those cases where the server only knows the value of the dynamic variable as used by the client within certain margins of accuracy, the prior art contains methods to resolve this uncertainty (for example various time or counter synchronization methods for time and/or counter based OTPs are well-known in the prior art). Hence, the success of the verification performed by (753) depends necessarily on the identity of the server public key (824) used in the respective calculations of client and server. If a MITMA has compromised the integrity of the channels (751) or (752), the respective versions of the server public key will not be identical, which will cause the verification in (753) to fail.

### BEST MODE FOR CARRYING OUT THE INVENTION

In a preferred embodiment, the method comprises the steps of a client initiating a secure communication session with a server; said server presenting a public key and public key certificate; said client and said server establishing a session key, derived from inter alia a random secret generated by said client, encrypted with said public key, and transmitted from said client to said server; said client and said server engaging in encrypted communication using said session key; said client deriving an authentication credential including a cryptographic function of at least a secret shared between said client and said server and said public key and preferably also a dynamic value implicitly or explicitly known to said client and said server; said client transmitting said authentication credential to said server; and said server verifying the validity of said authentication credential on the basis of at least said server's knowledge of said shared secret and said public key.

In a preferred embodiment, the method for a server to detect a man-in-the-middle attack against a communication session over a channel between a client and said server, where said communication session is initiated by said client and said server, comprises said server receiving an authentication credential from said client created by applying a cryptographic function to a secret shared between said client and said server, a public key and public key certificate presented by said server during session initialization, and a time value; and said server verifying validity of said authentication credential by applying a cryptographic function to said secret, said public key and public key certificate, and said time value.

In a preferred embodiment, the method for a client to allow a server to detect a man-in-the-middle attack against a communication session over a channel between said client and a server, where said communication session is initiated by said client and said server, comprises said client creating an authentication credential by applying a cryptographic function to at least a secret shared between said client and said server, a public key and public key certificate presented by said server during session initialization, and a time value; and said client transmitting said authentication credential to said server.

In a preferred embodiment of the present invention, operations of the methods specified above are implemented by means of an apparatus containing an integrated microelectronics circuit performing cryptographic operations, adapted to generate and/or verify an authentication credential using at least a base secret securely stored or entered into memory inside said apparatus and distinctive channel information.

In a preferred embodiment of the present invention, operations of the methods specified above are implemented by means of a program running on a computer, adapted to generate and/or verify an authentication credential using at least a base secret securely stored or entered in said computer and distinctive channel information.

### MODE(S) FOR CARRYING OUT THE INVENTION

In general, the method being disclosed to detect a man-in-the-middle attack against a communication between a client and a server comprises said client and said server initiating a communication session; said client deriving an authentication credential including a cryptographic function of at least a secret shared between said client and said server and distinctive channel information; said client transmitting said authentication credential to said server; and said server verifying the validity of said authentication credential on the basis of at least said server's knowledge of said shared secret and distinctive channel information.

In general, the method being disclosed for a server to detect a man-in-the-middle attack against a communication session over a channel between a client and said server, where said communication session is initiated by said client and said server, comprises said server receiving an authentication credential from said client created by applying a cryptographic function to at least a secret shared between said client and said server and distinctive channel information; and said server verifying validity of said authentication credential by applying a cryptographic function to at least a secret shared between said client and said server and distinctive channel information.

In general, the method being disclosed for a client to allow detection of a man-in-the-middle attack against a communication between said client and a server, where said communication session is initiated by said client and said server, comprises said client creating an authentication credential by applying a cryptographic function to at least a secret shared between said client and said server and distinctive channel information; and said client transmitting said authentication credential to said server.

In these methods, different elements can be used as distinctive channel information, and these can be combined with the shared secret in different ways. In one embodiment, said distinctive channel information concerns the channel or session itself. In another embodiment, said distinctive channel information concerns the channel end points. In one embodiment, said distinctive channel information includes the Internet Protocol address of the server, as it appears in the Internet Protocol messages exchanged between client and server. In yet another embodiment, said distinctive channel information includes the Domain Name of the server. In yet another embodiment, said distinctive channel information includes the Uniform Resource Locator as it is used by the client to access the server's web content. In a further embodiment, said distinctive channel information includes the Internet Protocol address of the client as it appears in the Internet Protocol messages exchanged between client and server. In one embodiment, said authentication credential is also a function of at least one dynamic value. In a typical embodiment said dynamic value is implicitly or explicitly known to both server and client within certain margins of accuracy. In one embodiment this dynamic value is a function of at least a time value. In another embodiment, said dynamic variable is a function of at least a counter value. In yet another embodiment, said dynamic variable is a function of at least a challenge transmitted by said server. In one more embodiment, said dynamic variable is a function of a message to be exchanged between said client and said server or transaction-related data.

In one set of embodiments, the communication channel is set up by means of a protocol that requires said server to present a public key and public key certificate; said client and said server to establish a session key, derived from inter alia a random secret generated by said client, encrypted with said public key, and transmitted from said client to said server; and said client and said server to engage in encrypted communication using said session key. In one embodiment said distinctive channel information includes said server public key presented by said server, or information mathematically derived therefrom, such as the server public key certificate. In another embodiment, said distinctive channel information includes said session key.

In a general embodiment of the present invention, operations of the methods specified above are implemented by means of an apparatus comprising an agent adapted to generate and/or verify an authentication credential using at least a base secret securely stored or entered into memory inside said apparatus and distinctive channel information. Said agent may be a microelectronic device such as an Application-Specific Integrated Circuit (ASIC) or a microprocessor. Different elements can be used as distinctive channel information, and these can be combined with the shared secret in different ways. In one embodiment, said distinctive channel information includes the server public key presented by the server to set up the secure channel, or information mathematically derived therefrom, such as the server public key certificate. In an embodiment, said distinctive channel information includes the key used to encrypt the data over the secure channel. In another embodiment, said distinctive channel information includes the Internet Protocol address of the server, as it appears in the Internet Protocol messages exchanged between client and server. In yet another embodiment, said distinctive channel information includes the Domain Name of the server. In yet another embodiment, said distinctive channel end point information includes the Uniform Resource Locator as it is used by the client to access the server's web content. In a further embodiment, said distinctive channel end point information includes the Internet Protocol address of the client as it appears in the Internet Protocol messages exchanged between client and server. In one embodiment, said authentication credential is also a function of at least one dynamic value. In a typical embodiment said dynamic value is implicitly or explicitly known to both server and client within certain margins of accuracy. In one embodiment this dynamic value is a function of at least a time value. In another embodiment, said dynamic variable is a function of at least a counter value. In yet another embodiment, said dynamic variable is a function of at least a challenge transmitted by said server. In one more embodiment, said dynamic variable is a function of a message to be exchanged between said client and said server or transaction-related data.

In another general embodiment of the present invention, operations of the methods specified above are implemented by means of a program running on a computer, adapted to generate and/or verify an authentication credential using at least a base secret and distinctive channel information. Different elements can be used as distinctive channel information, and these can be combined with the shared secret in different ways; each such combination may be used with a different storage technique of the shared secret. The program can be implemented in different forms. In one embodiment, said distinctive channel information includes the key used to encrypt the data over the secure channel. In an embodiment, said distinctive channel information includes the server public key presented by the server to set up the secure channel, or information mathematically derived therefrom, such as the server public key certificate. In another embodiment, said distinctive channel information includes the Internet Protocol address of the server, as it appears in the Internet Protocol messages exchanged between client and server. In yet another embodiment, said distinctive channel information includes the Domain Name of the server. In yet another embodiment, said distinctive channel information includes the Uniform Resource Locator as it is used by the client to access the server's web content. In a further embodiment, said distinctive channel information includes the Internet Protocol address of the client as it appears in the Internet Protocol messages exchanged between client and server. In one embodiment, said authentication credential is also a function of at least one dynamic value. In a typical embodiment said dynamic value is implicitly or explicitly known to both server and client within certain margins of accuracy. In one embodiment this dynamic value is a function of at least a time value. In another embodiment, said dynamic variable is a function of at least a counter value. In yet another embodiment, said dynamic variable is a function of at least a challenge transmitted by said server. In one more embodiment, said dynamic variable is a function of a message to be exchanged between said client and said server or transaction-related data. In one embodiment, said program is a JAVA applet. In another embodiment, said program is a plug-in for a web browser. In yet another embodiment, said program is an ActiveX applet. In one embodiment said shared secret is stored in said computer, e.g. in a cookie. In another embodiment, said shared secret is entered into the computer by means of a human interface device. In yet another embodiment, said shared secret is generated by an unconnected token and entered into the computer by means of a human interface device.

In another general embodiment of the present invention, operations of the methods specified above are implemented by means of a program running on a computer adapted to be coupled to a security device to generate and/or verify an authentication credential using at least a base secret securely stored in said security device and distinctive channel information. Different elements can be used as distinctive channel information, and these can be combined with the shared secret in different ways; each such combination may be used with a different storage technique of the shared secret. The program can be implemented in different forms and operate with different types of security devices. In one embodiment, said distinctive channel information includes the key used to encrypt the data over the secure channel. In an embodiment, said distinctive channel information includes the server public key presented by the server to set up the secure channel, or information mathematically derived therefrom, such as the server public key certificate. In another embodiment, said distinctive channel information includes the Internet Protocol address of the server, as it appears in the Internet Protocol messages exchanged between client and server. In yet another embodiment, said distinctive channel information includes the Domain Name of the server. In yet another embodiment, said distinctive channel information includes the Uniform Resource Locator as it is used by the client to access the server's web content. In a further embodiment, said distinctive channel information includes the Internet Protocol address of the client as it appears in the Internet Protocol messages exchanged between client and server. In one embodiment, said authentication credential is also a function of at least one dynamic value. In a typical embodiment said dynamic value is implicitly or explicitly known to both server and client within certain margins of accuracy. In one embodiment this dynamic value is a function of at least a time value. In another embodiment, said dynamic variable is a function of at least a counter value. In yet another embodiment, said dynamic variable is a function of at least a challenge transmitted by said server. In one more embodiment, said dynamic variable is a function of a message to be exchanged between said client and said server or transaction-related data. In one embodiment, said program is a JAVA applet. In another embodiment, said program is a plug-in for a web browser. In yet another embodiment, said program is an ActiveX applet. In one embodiment, said security device is a strong authentication token. In another embodiment, said security device is a USB token. In yet another embodiment, said security device is a smart card.

### REFERENCES

WO 02/091662 A (VASCO DATA SECURITY, INC.) 14 Nov. 2002
WO 85/03785 A (GORDIAN SYSTEMS, INC.) 29 Aug. 1985
FREIER, A., et al. The SSL 3.0 Protocol. Netscape Communications Corp. Nov. 18, 1996.
DIERKS, T., et al. RFC 4346: The Transport Layer Security (TLS) Protocol, Version 1.1. IETF Network Working Group. April 2006.
FERGUSON, Niels, et al. Practical Cryptography. Indianapolis: Wiley Publishing, 2003. ISBN 0471223573. p. 369.
SMITH, Richard E. Authentication: From Passwords to Public Keys. Addison-Wesley, 2002. ISBN 0201615991. p. 395.
MENNES, Frederik. Best Practices for Strong Authentication in Internet Banking. ISSA Journal. December 2007, p. 6-10.
ASOKAN, N., et al. Man-in-the-Middle in Tunneled Authentication Protocols. http://eprint.iacr.org/2002/163. Nov. 11, 2002.

1. A method to detect a man-in-the-middle attack against a communication session over a channel between a client and a server, where said communication session is initiated by said client and said server, said method comprising (1) said server receiving an authentication credential from said client created by applying a cryptographic function to at least a secret shared between said client and said server; and (2) said server performing verification of said authentication credential using at least said secret, characterized in that said cryptographic function and said verification operate on distinctive information respecting said channel.

2. The method of claim 1, further characterized in that said distinctive information includes a function of a key used to encrypt said communication session.

3. The method of claim 1, further characterized in that said distinctive information includes channel end point information.

4. The method of claim 3, further characterized in that said distinctive information includes server information.

5. The method of claim 3, further characterized in that said distinctive information includes client information.

6. The method of claim 4, further characterized in that said distinctive information includes a function of said server's server public key.

7. The method of claim 4, further characterized in that said distinctive information includes a function of said server's public key certificate.

8. The method of claim 4, further characterized in that said distinctive information includes said server's IP address.

9. The method of claim 4, further characterized in that said distinctive information includes said server's domain name.

10. The method of claim 4, further characterized in that said distinctive information includes said server's uniform resource locator.

11. The method of claim 5, further characterized in that said distinctive information includes said client's IP address.

12. The method of any of claims 1-5, further characterized in that said cryptographic function additionally operates on at least one dynamic value.

13. The method of claim 12, further characterized in that said at least one dynamic value is known within certain margins of accuracy at both said client and said server.

14. A method to allow detection of a man-in-the-middle attack against a communication session over a channel between a client and a server, where said communication session is initiated by said client and said server and said man-in-the-middle attack may be detected by said server performing a verification on an authentication credential created by said client, said method comprising (1) said client creating an authentication credential by applying a cryptographic function to at least a secret shared between said client and said server; and (2) said client transmitting said authentication credential to said server, characterized in that said cryptographic function operates on distinctive information respecting said channel.

15. The method of claim 14, further characterized in that said distinctive information includes a function of a key used to encrypt said communication session.

16. The method of claim 14, further characterized in that said distinctive information includes channel end point information.

17. The method of claim 16, further characterized in that said distinctive information includes server information.

18. The method of claim 16, further characterized in that said distinctive information includes client information.

19. The method of claim 17, further characterized in that said distinctive information includes a function of said server's server public key.

20. The method of claim 17, further characterized in that said distinctive information includes a function of said server's public key certificate.

21. The method of claim 17, further characterized in that said distinctive information includes said server's IP address.

22. The method of claim 17, further characterized in that said distinctive information includes said server's domain name.

23. The method of claim 17, further characterized in that said distinctive information includes said server's uniform resource locator.

24. The method of claim 18, further characterized in that said distinctive information includes said client's IP address.

25. The method of any of claims 14-18, further characterized in that said cryptographic function additionally operates on at least one dynamic value.

26. The method of claim 25, further characterized in that said at least one dynamic value is known within certain margins of accuracy at both said client and said server.

27. An apparatus adapted to generate or verify a client authentication credential for authenticating said client in a client-server transaction over a communication channel, said apparatus comprising an agent for performing a cryptographic function using a secret shared between said client and said server as part of said generating or verifying, characterized in that said cryptographic function also operates on or reproduces distinctive information respecting said channel.

28. The apparatus of claim 27, further characterized in that said distinctive information includes a function of a key used to encrypt communications over said communication channel.

29. The apparatus of claim 27, further characterized in that said distinctive information includes channel end point information.

30. The apparatus of claim 29, further characterized in that said distinctive information includes server information.

31. The apparatus of claim 29, further characterized in that said distinctive information includes client information.

32. The apparatus of claim 30, further characterized in that said distinctive information includes a function of said server's public key.

33. The apparatus of claim 30, further characterized in that said distinctive information includes a function of said server's public key certificate.

34. The apparatus of claim 30, further characterized in that said distinctive information includes said server's IP address.

35. The apparatus of claim 30, further characterized in that said distinctive information includes said server's domain name.

36. The apparatus of claim 30, further characterized in that said distinctive information includes said server's uniform resource locator.

37. The apparatus of claim 31, further characterized in that said distinctive information includes said client's IP address.

38. The apparatus of any of claims 27-31, further characterized in that said cryptographic function additionally operates on at least one dynamic value.

39. The apparatus of claim 38, further characterized in that said at least one dynamic value is known within certain margins of accuracy at both said client and said server.

40. A computer-readable storage medium containing a program for a computer which when executed generates or verifies a client authentication credential for authenticating said client in a client-server transaction over a communication channel wherein said credential is generated using at least a cryptographic function employing a secret shared between said client and said server, characterized in that said cryptographic function also operates on distinctive information respecting said channel.

41. The medium of claim 40, further characterized in that said distinctive information includes a function of a key used to encrypt communications over said communication channel.

42. The medium of claim 40, further characterized in that said distinctive information includes channel end point information.

43. The medium of claim 42, further characterized in that said distinctive information includes server information.

44. The medium of claim 42, further characterized in that said distinctive information includes client information.

45. The medium of claim 43, further characterized in that said distinctive information includes a function of said server's public key.

46. The medium of claim 43, further characterized in that said distinctive information includes a function of said server's public key certificate.

47. The medium of claim 43, further characterized in that said distinctive information includes said server's IP address.

48. The medium of claim 43, further characterized in that said distinctive information includes said server's domain name.

49. The medium of claim 43, further characterized in that said distinctive information includes said server's uniform resource locator.

50. The medium of claim 44, further characterized in that said distinctive information includes said client's IP address.

51. The medium of any of claims 40-44, further characterized in that said cryptographic function additionally operates on at least one dynamic value.

52. The medium of claim 51, further characterized in that said at least one dynamic value is known within certain margins of accuracy at both said client and said server.

53. The program of any of claims 40-44, further characterized in that said program is a JAVA applet.

54. The medium of any of claims 40-44, further characterized in that said program is a web browser plug-in.

55. The medium of any of claims 40-44, further characterized in that said program is an ActiveX applet.

56. The medium of any of claims 40-44, further characterized in that said secret is stored in a non-volatile memory in said computer.

57. The medium of any of claims 40-44, further characterized in that said program is adapted to accept said secret from a human interface device coupled to said computer.

58. The medium of claim 57, further characterized in that said secret is generated by an unconnected token.

59. The medium of any of claims 40-44, further characterized in that said program is configured to cooperate with a security device by passing information to it and receiving information from it.

60. The medium of claim 59, further characterized in that said security device is a strong authentication token.

61. The medium of claim 59, further characterized in that said security device is a USB token.

62. The medium of claim 59, further characterized in that said security device is a smart card.
